(19) United States
(12) Patent Application Publication
(10) Pub. No.: US 2020/0137671 A1
(43) Pub. Date: Apr. 30, 2020

(54) Wifi Network, and Networking Method Therefor and Data Transmission Method Therein

(71) Applicant: Espressif Systems (Shanghai) Co., Ltd., Shanghai (CN)

(72) Inventors: Jiangjian Jiang, Shanghai (CN); Yuexia Qi, Shanghai (CN); Lina Ye, Shanghai (CN)

(21) Appl. No.: 16/463,138

(22) PCT Filed: Apr. 27, 2018
(86) PCT No.: PCT/CN2018/084766

§ 371 Date: May 22, 2019

(30) Foreign Application Priority Data
May 17, 2017 (CN) 201710348148.8

(51) Int. Cl. H04W 48/16; H04L 29/12; H04L 12/18

(52) U.S. Cl. CPC H04W 48/16; H04W 84/18; H04L 12/185; H04L 61/2069

(57) ABSTRACT

The invention discloses a Wi-Fi networking method, the method comprises: an address definition in a MAC layer data structure comprises a target destination address and a group address of a Wi-Fi device; adding Wi-Fi devices in a same frequency band and having a same group address to a same Wi-Fi network. In the invention, one group address specifies one Wi-Fi network; any Wi-Fi devices in the same frequency band, as long as they have the same group address, are considered as being in the same network and establish one Wi-Fi network; any device is in a peer role, and there is no substantial connection relationship; any Wi-Fi device may freely join or leave the network; the number of devices in this network may tend to be infinite, the range of the network may tend to be infinitely wide, and various network topologies of different complexities are supported.

### TECHNICAL FIELD

The invention relates to the field of Wi-Fi technology, particularly to a Wi-Fi network as well as networking method and data transmission method therefor.

### BACKGROUND ART

Wi-Fi is a technology that enables electronic devices to be connected to a wireless local area network (WLAN), which usually uses radio frequency bands at 2.4G UHF or 5G SHF ISM. Connections to a wireless local area network are normally protected with passwords, but they may also be open, such that any device within the range of the WLAN may be allowed to be connected. Wi-Fi is a brand of wireless network communication technology, owned by the Wi-Fi Alliance. Its purpose is to improve the interoperability between wireless network products based on the IEEE 802.11 standards. Some call local area networks using IEEE 802.11 series protocols as wireless fidelity, and even considers Wi-Fi as an equivalent to wireless internet.

IoT is an important constituent part of the new generation of information technology, which is also an important stage of development of the “information” age. The English name for IoT is: “Internet of things (IoT)”. As suggested by its name, IoT is an internet connecting things. It contains two layers of meanings: firstly, the core and foundation of the IoT is still the internet, as it is a network extended and expanded on the basis of the internet; and secondly, its user end extends and expands to the information exchange and communication between any things, i.e., all things are connected. Through communication sensing technologies, such as intelligent sensing, recognition technologies, and ubiquitous computing, IoT is widely used in the fusion of the networks, so IoT is called a third wave in the development of the world information industry in succession to the computer and the internet.

Currently, Wi-Fi networking technologies in the prior art require an access point to perform networking, and the process of adding a device to a network is complicated, making it difficult for Wi-Fi devices to freely join or leave the network, and limiting the range of the network.

### SUMMARY OF THE INVENTION

The invention provides a Wi-Fi network as well as networking method and data transmission method therefor, in which Wi-Fi devices may freely join or leave the network, a number of devices in the network and the coverage of the network may be unlimited, and it may support multiple network topologies.

In order to achieve the above object, the invention provides a networking method for a Wi-Fi network, wherein the method comprises:

an address definition in the MAC layer data structure comprising a target destination address and a group address of a Wi-Fi device;

adding Wi-Fi devices in a same frequency band and having a same group address to a same Wi-Fi network.

The above described address definition in MAC layer further comprises a source address of the Wi-Fi device.

The above described Wi-Fi device operates in a Station/Client mode, and communicates in a MAC layer connectionless mode.

A topology of the above described Wi-Fi network comprises: star structure, ring structure, bus structure, distributed structure, tree structure, or mesh structure.

A frame body of the above described MAC layer data structure is application data.

A Wi-Fi network established through the above described networking method for a Wi-Fi network, wherein the network comprises any number of Wi-Fi device, wherein the Wi-Fi devices are in direction communication, or in indirection communication through other Wi-Fi device, and the Wi-Fi devices in the network have the same frequency band and the same group address.

A data transmission method for a Wi-Fi network, wherein the data transmission method comprises;

a plurality of Wi-Fi device establishing a Wi-Fi network through the above described Wi-Fi networking method;

a data transmitting device in the Wi-Fi devices performing data transmission to a data receiving device in a unicast, groupcast, or broadcast mode.

the data transmitting device and the data receiving device in the above described Wi-Fi network are directly communicatively connected;

in the unicast mode, the address definition in the MAC layer data structure of the data transmitting device comprises: the MAC address of the data transmitting device, the MAC address of the data receiving device, and the group address;

in the groupcast mode, the address definition in the MAC layer data structure of the data transmitting device comprises: the MAC address of the data transmitting device, a groupcast address, and the group address;

in the broadcast mode, the address definition in the MAC layer data structure of the data transmitting device comprises: the MAC address of the data transmitting device, a broadcast address, and the group address.

the data transmitting device and the data receiving device in the above described Wi-Fi network are indirectly communicatively connected via a relay device;

in the unicast mode, the address definition in the MAC layer data structure of the data transmitting device comprises: the MAC address of the data transmitting device, the MAC address of the relay device, and the group address; a header of the frame body contains the MAC address of the data receiving device; the address definition in the MAC layer data structure of the relay device comprises: the MAC address of the relay device, the MAC address of the data receiving device, and the group address;

in the groupcast mode, the address definition in the MAC layer data structure of the data transmitting device comprises: the MAC address of the data transmitting device, a groupcast address, and the group address; a header of the frame body contains the MAC address of the data receiving device; the address definition in the MAC layer data structure of the relay device comprises: the MAC address of the relay device, the groupcast address, and the group address;

in the broadcast mode, the address definition in the MAC layer data structure of the data transmitting device comprises: the MAC address of the data transmitting device, a broadcast address, and the group address; a header of the frame body contains the MAC address of the data receiving device; the address definition in the MAC layer data structure of the relay device comprises: the MAC address of the relay device, the broadcast address, and the group address.

As compared with the prior arts, a Wi-Fi network as well as a networking method and a data transmission method therefor according to the invention have the advantages that in the invention, the address definition comprises the target destination address and group address of the Wi-Fi device; one group address specifies one network; any Wi-Fi devices in the same frequency band, as long as they have the same group address, may be added to the same network upon power up of the device; any device is in a peer role, and there is no substantial connection relationship; any Wi-Fi device may freely join or leave the network; the number of devices in this network may tend to be infinite; the range of the network may tend to be infinitely wide, and various network topologies are supported.

### BRIEF DESCRIPTION OF THE DRAWINGS

FIG. 1 is an illustrative diagram of a data structure in MAC layer in a networking method for a Wi-Fi network according to the invention;

FIG. 2 is an illustrative diagram of a data structure defining frame control in a data structure in MAC layer;

FIG. 3 is an illustrative structural diagram of a Wi-Fi network according to the invention;

FIG. 4 is an illustrative diagram of a data structure in MAC layer when the Wi-Fi device according to the invention performs direct data transmission via unicast;

FIG. 5 is an illustrative diagram of a data structure in MAC layer when the Wi-Fi device according to the invention performs direct data transmission via groupcast;

FIG. 6 is an illustrative diagram of a data structure in MAC layer when the Wi-Fi device according to the invention performs direct data transmission via broadcast;

FIG. 7 is an illustrative diagram of a data structure in MAC layer of a data output device when the Wi-Fi device according to the invention performs indirect data transmission via unicast through a relay device;

FIG. 8 is an illustrative diagram of a data structure in MAC layer for the relay device when performing indirect data transmission via unicast;

FIG. 9 is an illustrative diagram of a data structure in MAC layer for the data output device when the Wi-Fi device according to the invention performs indirect data transmission via groupcast through a relay device;

FIG. 10 an illustrative diagram of a data structure in MAC layer for the relay device when performing indirect data transmission via groupcast;

FIG. 11 is an illustrative diagram of a data structure in MAC layer for the data output device when the Wi-Fi device according to the invention performs indirect data transmission via broadcast through a relay device;

FIG. 12 is an illustrative diagram of a data structure in MAC layer for the relay device when performing indirect data transmission via broadcast.

### DETAILED DESCRIPTION OF THE PREFERRED EMBODIMENTS

Particular embodiments of the invention will be further described with reference to the drawings.

The invention discloses an embodiment of a networking method for a Wi-Fi network which is applicable to IoT, the networking method particularly comprises the following steps:

S101) a Wi-Fi device operates in a Station/Client mode, and is configured to perform communication in a MAC layer connectionless mode.

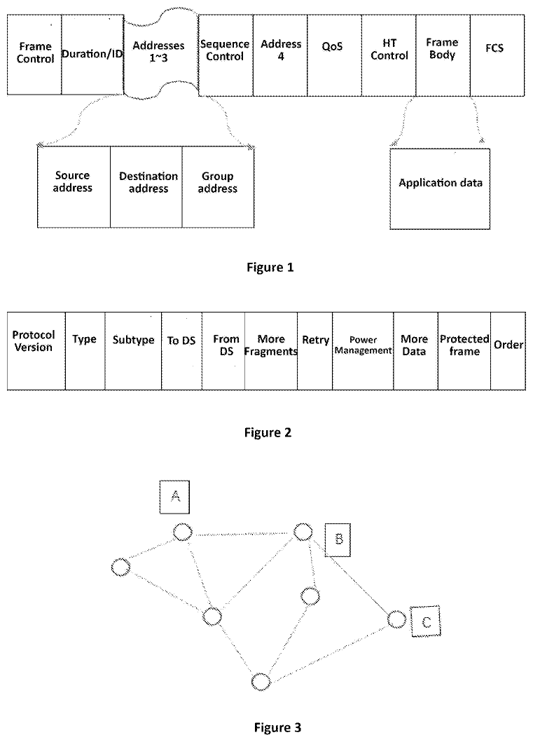

S102) As shown in FIG. 1, the MAC layer data structure adopts a standard 802.11 frame structure, comprises: Frame Control, Duration/ID, Addresses 1-3, Sequence Control, Address 4, QoS (Quality of Service) Control, HT Control (High Throughput Control), Frame Body, and FCS (Frame Check Sequence).

Here, the definition of the “Addresses 1-3” structure field comprises a target destination address, a source address, and a group address of Wi-Fi device.

Meanwhile, the “Frame Body” of the MAC layer data structure is application data.

As shown in FIG. 2, the definition of Frame Control in the MAC layer data structure comprises: Protocol Version, Type, Subtype, To DS (To Distributed System), From DS (From Distributed System), More Fragments, Retry, Power Management, More Data, Protected Frame, and Order.

Here, Type and Subtype are set to data type, ToDS and FromDS bits are both set to 0.

S103) the Wi-Fi devices in a same frequency band and having a same group address are determined to join the same Wi-Fi network. Thus, it is realized that Wi-Fi devices do not need to subject to connection establishing procedures to complete the establishment of a Wi-Fi network.

As shown in FIG. 3, an embodiment of a Wi-Fi network established through the above described Wi-Fi networking method is illustrated, the Wi-Fi network comprising any number of Wi-Fi devices. Here, Wi-Fi devices in the same frequency band and having the same group address are determined as in the same Wi-Fi network, i.e., these Wi-Fi devices form a Wi-Fi network, and this group address is an identification of the Wi-Fi network.

In the Wi-Fi network, Wi-Fi devices are in direction communication, or in indirection communication through other Wi-Fi device; for example, in the present embodiment, a device A and a device B are in direct wireless communication through Wi-Fi; the device B and a device C are in direct wireless communication through Wi-Fi; however, the device A and the device C establish indirect wireless communication through the device B.

The networking method for the Wi-Fi network may be as follows:

The Wi-Fi device A and a plurality of other Wi-Fi devices are in the same frequency band and have the same group address. According to the definition of the novel networking manner of the invention, these Wi-Fi devices join a same Wi-Fi network, and this group address is an identification of the network.

The Wi-Fi device A obtains information of all the devices in the current network via broadcast, which includes their MAC addresses.

Subsequently, the Wi-Fi device B and the Wi-Fi device C set their own group addresses to be the group address of the Wi-Fi device A, thereby joining the network of the Wi-Fi device A. Likewise, the Wi-Fi device A also obtains the MAC address information of the Wi-Fi device B and the Wi-Fi device C.

At this point, the Wi-Fi device A, the Wi-Fi device B, and the Wi-Fi device C have achieved joining a same mesh network upon power up, and may establish communication between each other.

Further, the Wi-Fi network formed by the networking, any Wi-Fi devices in the same frequency band, as long as they have the same group address, may be considered as being in the same network. Any device is in a peer role, there is no substantial connection relationship. Any Wi-Fi device may freely join or leave the network. The number of devices in this network may tend to be infinite, and the range of the network may tend to be infinitely wide. In addition, the Wi-Fi network may support various network topologies, including: star structure, ring structure, bus structure, distributed structure, tree structure, mesh structure, etc., which are especially suitable for complicated mesh topologies.

The invention further discloses a data transmission method for a Wi-Fi network, the data transmission method comprising the following steps:

S201) a plurality of Wi-Fi devices establish a Wi-Fi network through the above described Wi-Fi networking method.

S202) a data transmitting device in the Wi-Fi devices performs data transmission to a data receiving device in a unicast, groupcast, or broadcast mode.

Here, according to the communication connection relationships among the Wi-Fi devices, it may be divided into two circumstances: 1) data transmission when the data transmitting device and the data receiving device in the Wi-Fi network are directly communicatively connected; and 2) data transmission when the data transmitting device and the data receiving device in the Wi-Fi network are indirectly communicatively connected through a relay device.

1) when the data transmitting device and the data receiving device in the Wi-Fi network are directly communicatively connected, the data transmission method is as follows:

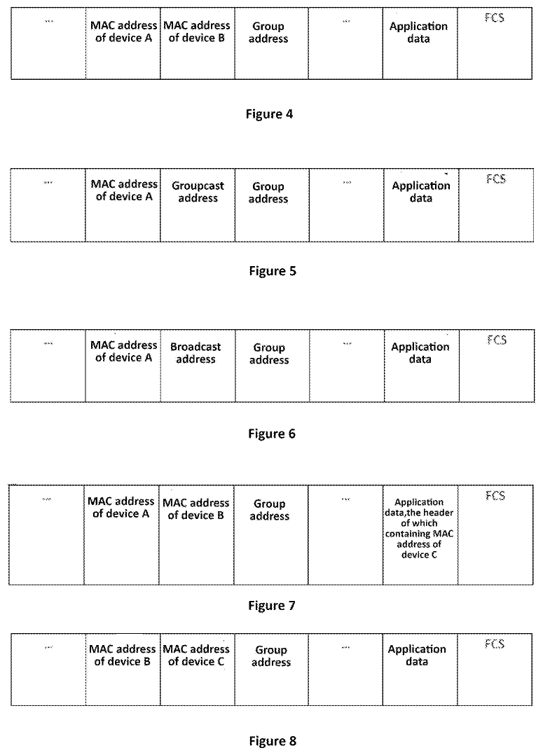

As shown in FIG. 4 with reference to FIG. 3, it illustrates a diagram of MAC layer data structure at the Wi-Fi device A end, when the Wi-Fi device A would like to transmit data to the Wi-Fi device B via unicast. In the unicast mode, the address definition in the MAC layer data structure of the Wi-Fi device A (i.e., the data transmitting device) comprises: the MAC address of the Wi-Fi device A, the MAC address of the Wi-Fi device B (i.e., the data receiving device), and the group address. In addition, the frame body is application data.

As shown in FIG. 5 with reference to FIG. 3, it illustrates a diagram of MAC layer data structure at the Wi-Fi device A end, when the Wi-Fi device A would like to transmit data to the Wi-Fi device B via groupcast. In the groupcast mode, the address definition in the MAC layer data structure of the device A comprises: the MAC address of the Wi-Fi device A, a groupcast address, and the group address. In addition, the frame body is application data.

As shown in FIG. 6 with reference to FIG. 3, it illustrates a diagram of MAC layer data structure at the Wi-Fi device A end, when the Wi-Fi device A would like to transmit data to the Wi-Fi device B via broadcast. In the broadcast mode, the address definition in the MAC layer data structure of the Wi-Fi device A comprises: the MAC address of the Wi-Fi device A, a broadcast address, and the group address. In addition, frame body is application data.

2) in a Wi-Fi network established as shown in FIG. 3, the Wi-Fi device A and the Wi-Fi device C are relatively distant from each other, and the Wi-Fi device A and the Wi-Fi device C establish a communication connection through the Wi-Fi device B. A circumstance where a data transmitting device and a data receiving device are in directly communicatively connected through a relay device is formed, with its data transmission method being as follows:

As shown in FIG. 7 with reference to FIG. 3, the Wi-Fi device A would like to transmit data to the Wi-Fi device C via unicast, but in view of the distance to Wi-Fi device retransmission through the Wi-Fi device B is needed.

In the unicast mode, in the MAC layer data structure of the data transmitting device (Wi-Fi device A), the address definition comprises: the MAC address of the Wi-Fi device A, the MAC address of the relay device (i.e., Wi-Fi device B), and the group address. The frame body is application data, and, a header of the frame body contains the MAC address of the data receiving device (i.e., Wi-Fi device C).

As shown in FIG. 8, it illustrates a diagram of the MAC layer data structure at the Wi-Fi device B end. After having received data from the Wi-Fi device A, the Wi-Fi device B extracts the MAC address of the Wi-Fi device C from the header of the application data and then retransmit the data to the Wi-Fi device C.

In the MAC layer data structure at the Wi-Fi device B end, the address definition in the MAC layer data structure of the Wi-Fi device B comprises: the MAC address of the Wi-Fi device B, the MAC address of the data receiving device, and the group address. The frame body is application data.

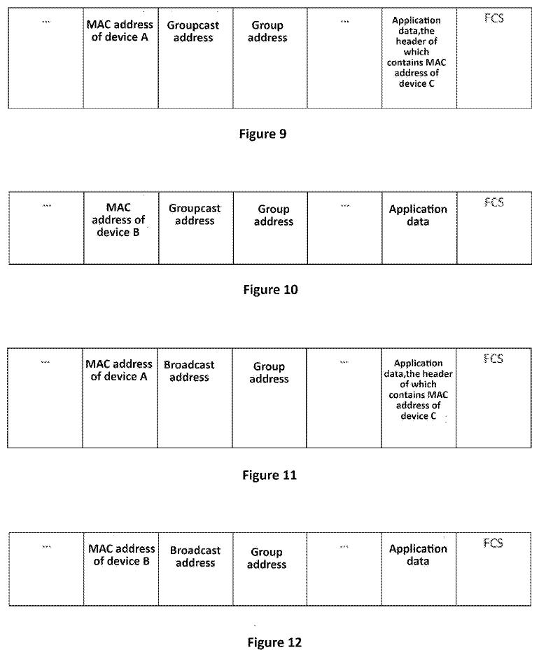

As shown in FIG. 9 with reference to FIG. 3, the Wi-Fi device A would like to retransmit data to the Wi-Fi device C via groupcast, but in view of its distance to the Wi-Fi device C, retransmission through the Wi-Fi device B is needed.

In the groupcast mode, the address definition in the MAC layer data structure of the data transmitting device (Wi-Fi device A) comprises: the MAC address of the Wi-Fi device A, the groupcast address, and the group address. The frame body is application data, and a header of the frame body contains the MAC address of the data receiving device (Wi-Fi device C).

As shown in FIG. 10, it illustrates a diagram of the MAC layer data structure at the Wi-Fi device B (relay device) end, after having received the data from the Wi-Fi device A, the Wi-Fi device B extracts the MAC address of the Wi-Fi device C from the header of the application data and retransmits the data to the Wi-Fi device C. In the MAC layer data structure at the Wi-Fi device B end, the address definition in the MAC layer data structure of the Wi-Fi device B comprises: the MAC address of the Wi-Fi device B, the groupcast address, and the group address. The frame body is application data.

As shown in FIG. 11 with reference to FIG. 3, the Wi-Fi device A would like to transmit data to the Wi-Fi device C via broadcast, but in view of its distance to the Wi-Fi device C, retransmission through the Wi-Fi device B is needed.

In the broadcast mode, the address definition in the MAC layer data structure of the data transmitting device (Wi-Fi device A) comprises: the MAC address of the Wi-Fi device A, the broadcast address, and the group address. The frame body is application data, and a header of the frame body contains the MAC address of the data receiving device (Wi-Fi device C).

As shown in FIG. 12, it illustrates a diagram of the MAC layer data structure at the Wi-Fi device B (relay device) end, after having received the data from the Wi-Fi device A, the Wi-Fi device B extracts the MAC address of the Wi-Fi device C from the header of the application data and then retransmits the data to the Wi-Fi device C.

In the MAC layer data structure of the Wi-Fi device B, the address definition comprises: the MAC address of the relay device, the broadcast address, and the group address. The frame body is application data.

Although the disclosure of the invention is described in detail with reference to the above described preferred embodiments, it shall be understood that the above described description shall not be considered as limitations to the invention. A person of ordinary skilled in the art shall understand that various modifications and substitutions to the invention will become apparent after reading the above described disclosure. Thus, the scope of protection of the invention shall be defined according to the appended claims.

1. A networking method for a Wi-Fi network, wherein the method comprises:
an address definition in a MAC layer data structure comprising a target destination address and a group address of a Wi-Fi device; and
adding Wi-Fi devices in a same frequency band and having a same group address to a same Wi-Fi network.

2. The networking method for a Wi-Fi network according to claim 1, wherein the address definition in MAC layer further comprises a source address of the Wi-Fi device.

3. The networking method for a Wi-Fi network according to claim 1, wherein the Wi-Fi device operates in a Station/Client mode, and communicates in a MAC layer connectionless mode.

4. The networking method for a Wi-Fi network according to claim 1, wherein a topology of the Wi-Fi network comprises: star structure, ring structure, bus structure, distributed structure, tree structure, or mesh structure.

5. The networking method for a Wi-Fi network according to claim 1, wherein a frame body of the MAC layer data structure is application data.

6. A Wi-Fi network established through the networking method for a Wi-Fi network according to claim 1, wherein the network comprises any number of Wi-Fi devices, wherein the Wi-Fi devices are in direction communication, or in indirection communication through other Wi-Fi device, and the Wi-Fi devices in the network have the same frequency band and the same group address.

7. A data transmission method for a Wi-Fi network, wherein the data transmission method comprises:
a plurality of Wi-Fi devices establishing a Wi-Fi network through the Wi-Fi networking method according to claim 1, and
a data transmitting device in the Wi-Fi devices performing data transmission to a data receiving device in a unicast, groupcast, or broadcast mode.

8. The data transmission method for a Wi-Fi network according to claim 7, wherein the data transmitting device and the data receiving device in the Wi-Fi network are directly communicatively connected;
in the unicast mode, the address definition in the MAC layer data structure of the data transmitting device comprises: the MAC address of the data transmitting device, the MAC address of the data receiving device, and the group address;
in the groupcast mode, the address definition in the MAC layer data structure of the data transmitting device comprises: the MAC address of the data transmitting device, a groupcast address, and the group address;
in the broadcast mode, the address definition in the MAC layer data structure of the data transmitting device comprises: the MAC address of the data transmitting device, a broadcast address, and the group address.

9. The data transmission method for a Wi-Fi network according to claim 7, wherein the data transmitting device and the data receiving device in the Wi-Fi network are in indirection communication via a relay device;
in the unicast mode, the address definition in the MAC layer data structure of the data transmitting device comprises: the MAC address of the data transmitting device, the MAC address of the relay device, and the group address; a header of the frame body contains the MAC address of the data receiving device; the address definition in the MAC layer data structure of the relay device comprises: the MAC address of the relay device, the MAC address of the data receiving device, and the group address;
in the groupcast mode, the address definition in the MAC layer data structure of the data transmitting device comprises: the MAC address of the data transmitting device, a groupcast address, and the group address; a header of the frame body contains the MAC address of the data receiving device; the address definition in the MAC layer data structure of the relay device comprises: the MAC address of the relay device, the groupcast address, and the group address;
in the broadcast mode, the address definition in the MAC layer data structure of the data transmitting device comprises: the MAC address of the data transmitting device, a broadcast address, and the group address; a header of the frame body contains the MAC address of the data receiving device; the address definition in the MAC layer data structure of the relay device comprises: the MAC address of the relay device, the broadcast address, and the group address.

10. A Wi-Fi network established through the networking method for a Wi-Fi network according to claim 2, wherein the network comprises any number of Wi-Fi devices, wherein the Wi-Fi devices are in direction communication, or in indirection communication through other Wi-Fi device, and the Wi-Fi devices in the network have the same frequency band and the same group address.

11. A Wi-Fi network established through the networking method for a Wi-Fi network according to claim 3, wherein the network comprises any number of Wi-Fi devices, wherein the Wi-Fi devices are in direction communication, or in indirection communication through other Wi-Fi device, and the Wi-Fi devices in the network have the same frequency band and the same group address.

12. A Wi-Fi network established through the networking method for a Wi-Fi network according to claim 4, wherein the network comprises any number of Wi-Fi devices, wherein the Wi-Fi devices are in direction communication, or in indirection communication through other Wi-Fi device, and the Wi-Fi devices in the network have the same frequency band and the same group address.

13. A Wi-Fi network established through the networking method for a Wi-Fi network according to claim 5, wherein the network comprises any number of Wi-Fi devices, wherein the Wi-Fi devices are in direction communication, or in indirection communication through other Wi-Fi device, and the Wi-Fi devices in the network have the same frequency band and the same group address.

14. A data transmission method for a Wi-Fi network, wherein the data transmission method comprises:
a plurality of Wi-Fi devices establishing a Wi-Fi network through the Wi-Fi networking method according to claim 2; and
a data transmitting device in the Wi-Fi devices performing data transmission to a data receiving device in a unicast, groupcast, or broadcast mode.

15. A data transmission method for a Wi-Fi network, wherein the data transmission method comprises:
a plurality of Wi-Fi devices establishing a Wi-Fi network through the Wi-Fi networking method according to claim 3; and
a data transmitting device in the Wi-Fi devices performing data transmission to a data receiving device in a unicast, groupcast, or broadcast mode.

16. A data transmission method for a Wi-Fi network, wherein the data transmission method comprises:
a plurality of Wi-Fi devices establishing a Wi-Fi network through the Wi-Fi networking method according to claim 4; and
a data transmitting device in the Wi-Fi devices performing data transmission to a data receiving device in a unicast, groupcast, or broadcast mode.

17. A data transmission method for a Wi-Fi network, wherein the data transmission method comprises:
a plurality of Wi-Fi devices establishing a Wi-Fi network through the Wi-Fi networking method according to claim 5; and
a data transmitting device in the Wi-Fi devices performing data transmission to a data receiving device in a unicast, groupcast, or broadcast mode.
